(19) United States
(12) Patent Application Publication
(10) Pub. No.: US 2010/0103136 A1
(43) Pub. Date: Apr. 29, 2010

(54) IMAGE DISPLAY DEVICE, IMAGE DISPLAY METHOD, AND PROGRAM PRODUCT

(75) Inventors: Ryo ONO, Tokyo (JP); Kei YAMAJI, Kanagawa (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/606,786

(22) Filed: Oct. 27, 2009

(30) Foreign Application Priority Data
Oct. 28, 2008 (JP) 2008-276974

(51) Int. Cl. G06F 3/041

(52) U.S. Cl. 345/173

(57) ABSTRACT

An image display device includes a display unit (DU) and an operation screen, a first operation unit on the DU generating an operation signal, a second operation unit on a rear of the DU generating an operation signal, a hold state (HS) detection unit detecting a HS of the image display device, an image display mode decision unit determining an image display mode for displaying the image on the DU according to the HS, an image processor determining a content of the image to be displayed according to the HS, and an operation control unit controlling the first and second operation units according to the HS. A user interface of the DU is changed to a user interface corresponding to the HS by changing, according to the HS, one or more of the image display mode/content of the image, and a method for controlling the first and second operation units.

The present application claims priority of Japanese Patent Application No. 2008-276974, which is herein incorporated in its entirety by reference. Further, the entire contents of the documents cited in this specification are incorporated herein by reference.

### BACKGROUND OF THE INVENTION

The present invention relates to an image display device provided with a touch panel on a front side and a touch panel or a touch pad on a rear and/or a lateral side, an image display method, and a program product, providing an optimum user interface corresponding to a hold state of the image display device. This is achieved by changing the image display method, displayed content, and a method of controlling the touch panel or the touch pad according to the hold state of the display device.

Conventionally, a digital photograph frame (referred to also as DPF below), which is one of the image display devices, only provides the same user interface for displaying an image whether the DPF is placed on a desk, etc. for viewing the image or held by the operator in his/her hands for viewing an image. Among the portable music players capable of displaying an image, some use a touch panel and others change a display direction of the image depending upon a direction in which such players are held by means of an acceleration sensor, etc.

JP 2007-164767 A describes an information display and input device provided with keys on the rear side of the display unit. The main body thereof is supported by the palms of the hands, allowing the key operations to be performed using the index to little fingers. The device permits verification of the depressed key and its neighboring keys and correction thereof where necessary. Upon depression of a key, a keyboard image is displayed on the display device for verification of the depressed position. Further, visual verification of the finger performing the depression on the touch panel is possible from the front side because of a transparent material used to form the area corresponding to the keyboard image.

A website of “lucidTouch”, a double-sided multi-touch panel (URL: http://japanese.engadget.com/2007/08/24/microsoft-research-lucidtouch/) provided by Microsoft Research describes a multi-touch input interface as used in display device having a touch pad on a rear side thereof. The display device is supported by the palms of the hands, and the touch pad on the rear side is operated by an index to a little fingers. The movements of the fingers are captured by a camera mounted on an arm member extending out from behind the rear side, and the translucent fingers are superimposed on a screen as though the operator could see the rear side through the screen.

### SUMMARY OF THE INVENTION

However, when the operator holds a display device in his/her hands to view the displayed image, the finger movements are so restricted as compared with when it is placed on a desk, etc. that the operator often had difficulty in operation with the same user interface as is used when the display device is placed on a desk, etc.

The information display and input device described in the JP 2007-164767 A permits key input by means of the touch panel provided on the rear side. To ensure that the characters are entered correctly by the operation performed on the rear side, the depressed key is indicated on the screen to allow visual verification of the key of which the character has been entered. Thus, a key display, added to the displayed content, obstructs the view and makes it impossible to perform operations while fully enjoying viewing the displayed content. Further, the operation panel is provided only on the rear side and there is no description therein that the operation panel is provided on both the front and rear sides.

The multi-touch input interface described in the above website captures the movements of fingers with the camera extending out from the rear side, and thus this camera extending from the rear side impairs the portability of the imaging device and makes application of the multi-touch input interface to the DPF impractical.

An object of the present invention is to eliminate the above problems associated with the prior art and provide an image display device, an image display method, and a program product, wherein the image display device automatically switches to an optimum user interface according to usage and the hold state thereof, thus allowing the operator to perform operations while fully enjoying viewing the displayed content.

In order to achieve the above-described object, the present invention provides an image display device for displaying an image comprising: a display unit for displaying at least one of the image and an operation screen, a first operation unit provided on the display unit and for generating an operation signal by detecting a contact with itself, a second operation unit provided on a rear side of the display unit and for generating an operation signal by detecting a contact with itself, a hold state detection unit for detecting a hold state of the image display device according to the operation signal generated by at least one of the first operation unit and the second operation unit, an image display mode decision unit for determining an image display mode for displaying the image on the display unit according to the hold state detected by the hold state detection unit, an image processor for determining a content of the image to be displayed on the display unit according to the hold state detected by the hold state detection unit, and an operation control unit for controlling the first operation unit and the second operation unit according to the hold state detected by the hold state detection unit, wherein a user interface of the display unit is changed to a user interface corresponding to the hold state of the image display device by performing one or more of processing by the image display mode decision unit to change the image display mode for displaying the image on the display unit according to the detected hold state, processing by the image processor to change the content of the image to be displayed on the display unit according to the detected hold state, and processing by the operation control unit to change a method for controlling the first operation unit and the second operation unit according to the detected hold state.

Here, it is preferred that when the hold state detection unit detects that the first operation unit is operated by an operator's thumbs whereas the second operation unit is operated by one or more of the operator's index finger, middle finger, ring finger, and little finger, the hold state detection unit detects that the hold state is such that the image display device is held in the operator's both hands.

It is preferred that when the hold state is such that the image display device is held in the operator's both hands, the image and the operation screen displayed in the display unit are associated with a movable range of one of the operator's fingers operating the second operation unit, the movable range being estimated by detecting a length of the one operating finger and being smaller than a screen of the display unit.

It is preferred that the movable range of the one finger operating the second operation unit is changed according to a position where the image display device is supported.

It is preferred that when three fingers of the index finger, middle finger, ring finger, and little finger are in contact with the second display unit, remaining one finger is judged to be the one finger operating the second operation unit.

It is preferred that the second operation unit is also provided on a lateral side of the display unit.

It is preferred that when the hold state is such that the image display device is placed on a desk or a table or held in the operator's single hand, the image display device is operated using only the first operation unit.

It is preferred that the first operation unit provided on the display unit is a touch panel.

It is preferred that a display unit for displaying at least one of the image and the operation screen is provided also on the rear side.

It is preferred that the second operation unit is a touch panel provided on the display unit on the rear side.

It is preferred that the image display device is a digital photograph frame.

Furthermore, the present invention provides an image display device for displaying an image comprising: a display unit for displaying at least one of the image and an operation screen, a first operation unit provided on the display unit and for generating an operation signal by detecting a contact with itself, a second operation unit provided on a lateral side of the display unit and for generating an operation signal by detecting a contact with itself, a hold state detection unit for detecting a hold state of the image display device according to the operation signal generated by at least one of the first operation unit and the second operation unit, an image display mode decision unit for determining an image display mode for displaying the image on the display unit according to the hold state detected by the hold state detection unit, an image processor for determining a content of the image to be displayed on the display unit according to the hold state detected by the hold state detection unit, and an operation control unit for controlling the first operation unit and the second operation unit according to the hold state detected by the hold state detection unit, wherein a user interface of the display unit is changed to a user interface corresponding to the hold state of the image display device by performing one or more of processing by the image display mode decision unit to change the image display mode for displaying the image on the display unit according to the detected hold state, processing by the image processor to change the content of the image to be displayed on the display unit according to the detected hold state, and processing by the operation control unit to change a method for controlling the first operation unit and the second operation unit according to the detected hold state.

Here, it is preferable that when the hold state is such that the image display device is placed on a desk or a table or held in the operator's single hand, the image display device is operated using only the first operation unit.

It is preferable that the first operation unit provided on the display unit is a touch panel.

It is preferable that a display unit for displaying at least one of the image and the operation screen is provided also on the lateral side.

It is preferable that the second operation unit is a touch panel provided on the display unit on the lateral side.

It is preferable that the image display device is a digital photograph frame.

Furthermore, the present invention provides an image display method for displaying an image on an image display device comprising a display unit for displaying the image and an operation screen, a first operation unit provided on the display unit, and a second operation unit provided on a rear side of the display unit, comprising the steps of: a step of displaying the image and the operation screen on the display unit, a step of generating a first operation signal by detecting through the first operation unit a contact with the first operation unit itself, a step of generating a second operation signal by detecting through the second operation unit a contact with the second operation unit itself, a step of detecting a hold state of the image display device according to at least one of the first operation signal and the second operation signal, a step of determining an image display mode for displaying the image on the display unit according to the hold state, a step of determining a content of the image to be displayed on the display unit according to the hold state, a step of controlling the display unit, the first operation unit and the second operation unit according to the hold state, and a step of changing a user interface of the display unit to a user interface corresponding to the hold state of the image display device by changing, according to the hold state, one or more of the image display mode of the image, the content of the image, and a method for controlling the first operation unit and the second operation unit.

Furthermore, the present invention provides a program product for causing a computer to execute an image display method for displaying an image on an image display device comprising a display unit for displaying the image and an operation screen, a first operation unit provided on the display unit, and a second operation unit provided on a rear side of the display unit, the program product comprising the steps of: a step of displaying the image and the operation screen on the display unit, a step of acquiring a first operation signal generated by detecting through the first operation unit a contact with the first operation unit itself, a step of acquiring a second operation signal generated by detecting through the second operation unit a contact with the second operation unit itself, a step of detecting a hold state of the image display device according to at least one of the first operation signal and the second operation signal, a step of determining an image display mode for displaying the image on the display unit according to the hold state, a step of determining a content of the image to be displayed on the display unit according to the hold state, a step of controlling the display unit, the first operation unit and the second operation unit according to the hold state, and a step of changing a user interface of the display unit to a user interface corresponding to the hold state of the image display device by changing, according to the hold state, one or more of the image display mode of the image, the content of the image, and a method for controlling the first operation unit and the second operation unit.

Here, it is preferable that the computer is a computer forming a part of the image display device.

According to the present invention, the image display device automatically switches to an optimum user interface according to the hold state to change the display content by detecting the usage and the hold state thereof, so that the operator can perform operations while fully enjoying viewing the displayed content with the optimum user interface.

According to an embodiment of the invention, operation efficiency can be increased by performing operations using the touch panel on the front side and the touch panel or touch pad on the rear side and/or the lateral side.

Further, according to an embodiment of the invention, operation efficiency can be increased by correlating the display screen with areas in the touch panel or the touch pad on the rear side and/or the lateral side that can be reached by the fingers.

### BRIEF DESCRIPTION OF THE DRAWINGS

FIG. 1 is a block diagram illustrating a schematic configuration of the DPF according to an embodiment of the invention.

FIGS. 2A and 2B are schematic views illustrating external appearances of the DPF of the invention.

FIGS. 3A and 3B are views for explaining a first example of operation of the DPF of the invention as it is held in both hands.

FIG. 4 is a view for explaining a second example of operation according to the invention.

FIG. 5 is a view for explaining the second example of operation according to the invention.

FIG. 6A is a rear view of the PDF for explaining a case of operation where an operator's hands are small or the DPF is large relative to the hands holding it; FIG. 6B is a front view for explaining the same case. FIG. 6C is a view for explaining how the length of a finger is determined; FIG. 6D is a view for explaining the correlation between the ranges of finger movements and the display unit.

FIG. 7 is a view for explaining a case where the operator holds the lower side of the DPF.

FIGS. 8A and 8B are views for explaining different operating fingers producing differences in operation.

FIG. 9 is a view for explaining a third example of operation according to the invention.

FIG. 10 is a view for explaining the third example of operation according to the invention.

### DETAILED DESCRIPTION OF THE INVENTION

The following describes in detail the image display device of the present invention based upon the preferred embodiments illustrated in the accompanying drawings.

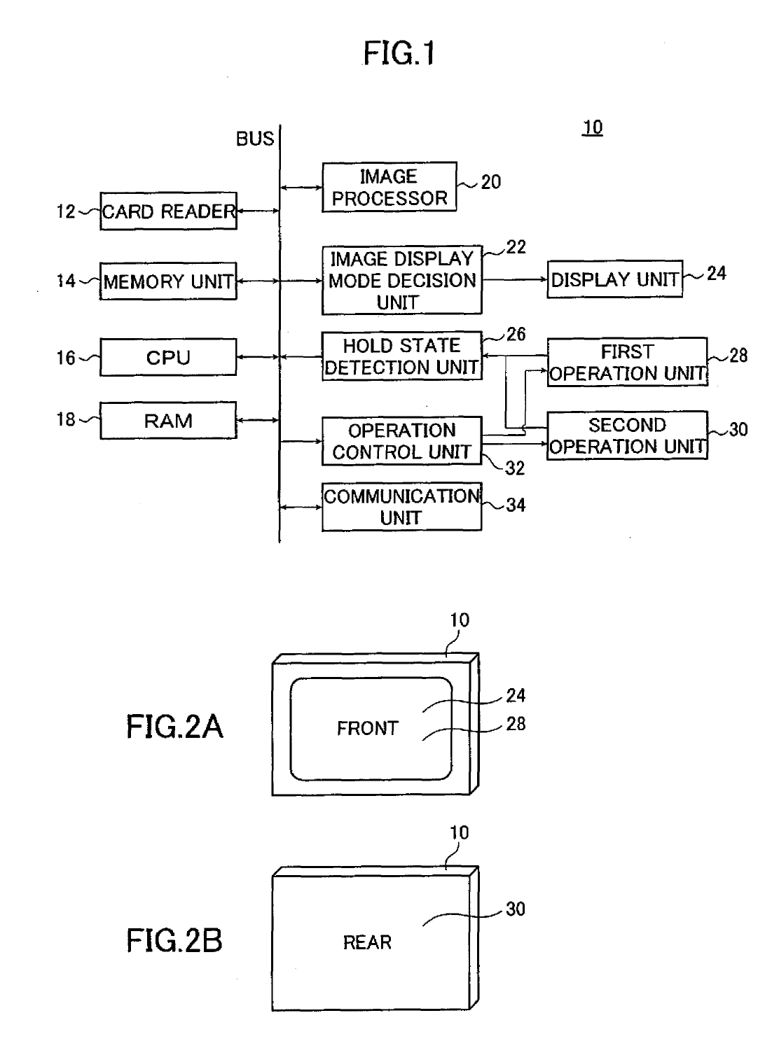

FIG. 1 is a block diagram illustrating an embodiment of configuration of the image display device according to the invention; FIGS. 2A and 2B are schematic views illustrating external appearances of a DPF 10, which is the image display device of the invention.

The DPF 10 as the image display device illustrated in FIG. 1 comprises a card reader 12, a memory unit 14, a CPU 16, a RAM 18, an image processor 20, an image display mode decision unit 22, a display unit 24, a hold state detection unit 26, a first operation unit 28, a second operation unit 30, an operation control unit 32, and a communication unit 34.

The card reader 12 is a means for entering image data, etc. to be displayed on the DPF 10. Through the card reader 12, image data, etc. can be read from an SD memory card, an xD picture card, and the like and entered in the DPF 10. The card reader 12 may be provided with a USB (Universal Serial Bus) interface so that image data, etc. can be read from a USB memory, etc and entered in the DPF 10.

The memory unit 14 stores entered image data, etc.; it may be an HDD (Hard Disk Drive), an SSD (Solid State Drive), or the like.

The CPU 16 controls such units as the card reader 12 and the memory unit 14 among its functions and may be any of various CPUs as appropriate. Considering the portability of the DPF, a CPU of a type that is embedded for use is preferable. Such a CPU is exemplified by a CPU having a MIPS (trademark) architecture and a CPU having an ARM (trademark) architecture.

The RAM 18 is a memory provided to temporarily store results of computation by the CPU 16 and the like.

The image processor 20 performs image processing such as scroll, rotation, frame superposition, etc. on displayed image data, image processing such as superposition of menu buttons on the image data, and the like. The data processed by the image processor 20 is sent to the image display mode decision unit 22 described later and displayed on the display unit 24. The display unit 24 may display not only a still image but also other content such as a moving image and a text. The display unit 24 can display the content and the menu buttons either alone or superimposed.

The image display mode decision unit 22 determines a image display mode of the display unit 24 from hold state information detected by the hold state detection unit 26 described later. For example, when the DPF 10 is placed on a desk (or any other table on which the DPF 10 can be placed), a user interface is selected that permits easy viewing of an image and easy operation of the device on the desk using only the first operation unit 28, which is a touch panel provided on a front side of the DPF 10 as will be described; when the DPF 10 is held in both hands, a user interface is selected that permits easy operation of the device performed with both hands using both of the touch panel provided on the front side, i.e., the first operation unit 28, and a touch panel and/or a touch pad provided on a rear side and a lateral side of the DPF 10, i.e., the second operation unit 30.

The display unit 24 is provided on the front side of the DPF 10 illustrated in FIG. 2A and can display image data, operation buttons, etc. using an FPD (Flat Panel Display). The FPD may use, for example, liquid crystal, organic EL (Electro luminescence), and the like.

The hold state detection unit 26 detects the hold state of the DPF 10: when the operator touches the first operation unit 28 and the second operation unit 30 described later, an operation signal is generated, whereupon the hold state detection unit 26 receives the operation signal and generates operation information to detect the hold state of the DPF 10.

When neither the first operation unit 28 nor the second operator unit 30 generates the operation signal, the hold state detection unit 26 judges the DPF 10 to be placed on a desk, etc., and generates the hold state information accordingly. When only the first operation unit 28 provided on the front side of the display unit 24 is generating the operation signal, the hold state detection unit 26 judges that the operator operates the DPF 10 as placed on the desk, etc. and generates the operation information and the hold state information accordingly.

When only the second operator unit 30 provided on the rear side of the DPF 10 illustrated in FIG. 2B is generating the operation signal, or when both the first operation unit 28 and the second operation unit 30 are generating the operation signal, the hold state detection unit 26 judges the DPF 10 to be held in both hands or in a single hand.

When the DPF 10 is held in both hands, the second operation unit 30 is touched by the fingers of both hands. Thus, the hold state detection unit 26 can judge that the DPF 10 is held in both hands from the operation signals corresponding to the positions of the second operation unit 30 touched by the fingers of both hands.

When the DPF 10 is held in a single hand, i.e., either right hand or left hand, the second operation unit 30 is touched by the fingers of the single hand. Thus, the hold state detection unit 26 can judge which of the right hand and the left hands holds the DPF 10 from the operation signals corresponding to the positions of the second operation unit 30 touched by the fingers. The hold state information is generated according to the result of judgment of these hold state.

Various sensors such as acceleration sensors may be provided as means for detecting the hold state other than the first operation unit and the second operation unit.

The finger being used for operation is identified by, for example, detecting that the finger performing the operation detaches (hovers) from the second operation unit 30 more frequently during operation than the other fingers in contact with the rear side of the DPF 10 according to the operation signal from the second operation unit 30, whereupon operating finger identification information is generated.

The operation information, the hold state information, and the operating finger identification information thus generated are sent to the image display mode decision unit 22, the operation control unit 32 described later, and other units.

The first operation unit 28 is a touch panel provided on the front side of the DPF 10 illustrated in FIG. 2A and may be a variety of touch panels including a touch panel using a resistive film type and a touch panel of a capacitance type. The first operation unit 28 is provided on the FPD of the display unit 24 and permits such operations as depressing the operation buttons, etc. displayed on the FPD with a finger, a touch pen, etc., and moving the displayed image directly, and etc. The first operation unit 28 sends operation signal to the hold state detection unit 26.

The second operation unit 30 is provided on the rear side of the DPF 10 illustrated in FIG. 2B and may be a touch panel or a touch pad. Where the display unit 24 is formed of a material that permits light to pass through it to the rear side, the second operation unit 30 is formed using a touch panel to secure optical transparency; where the display unit 24 is formed of a material that is not optically transparent, the second operation unit 30 need not permit the light to pass through it and hence is formed of a touch pad. Both the touch panel and the touch pad may be any of various types including the resistive film type and the capacitance type.

The second operation unit 30 generates operation signal representing movement of the finger performing operations such as movement of upwards, downwards, rightwards, leftwards, etc., and sends the operation signal to the hold state detection unit 26. The operation signal generated by the second operation unit 30 may be correlated with the coordinates in the first operation unit 28 on the front side.

The second operation unit 30 may be located on a lateral side of the DPF 10. The second operation unit 30 on a lateral side of the DPF 10 can also detect, for example, whether the DPF 10 is held in the single hand or in both hands, as in the case where the second operation unit 30 is provided on the rear side of the DPF 10. In this case, operations may be performed with a tip of the index fingers. Further, a slim and long display unit may be provided on the lateral side of the DFP 10, and the second operation unit 30 may be provided as a touch panel so that thumbnail images and operation buttons may be displayed in the slim and long display unit and used for operation.

Alternatively, the first operation unit 28 may be provided on the front side of the DPF 10, and the second operation unit 30 may be provided on both the rear side and the lateral side.

On the rear side of the DPF 10, the second operation unit 30 need not be located in alignment with the display unit 24 but may be out of alignment with the display unit 24. For example, where the DPF 10 has a foldable configuration, the second operation unit 30 may be provided on an inner side of the upper housing whereas the display unit 24 and the first operation unit 28 may be provided on an inner side of the lower housing so that when the upper housing is opened and turned a whole revolution, the second operation unit 30 may be positioned on the rear side, opposite from the display unit 24. Alternatively, the display unit 24 and the first operation unit 28 may be provided on the inner side of the upper housing whereas the second operation unit 30 may be provided on an outer side, i.e., the rear side of the lower housing, so that when the upper housing is opened and turned a half revolution, the second operation unit 30 provided on the rear side of the lower housing may be used to operate the screen displayed on the display unit 24 on the inner side of the upper housing. In this case, an additional display unit and operation unit may be provided on the inner side, i.e., on the front side of the lower housing.

As a variation, the DPF 10 may be so configured that the upper and lower housings can be slid laterally or longitudinally relative to each other from their normally aligned, stacked positions. The display unit 24 and the first operation unit 28 may be provided on the front side (an outer side) of the upper housing whereas the second operation unit 30 may be provided on the rear side (an outer side) of the lower housing of the slide type DPF 10. In this case, a keyboard, etc. for entering characters may be provided on the front side (an inner side) of the lower housing.

The operation control unit 32 controls the first operation unit 28 and the second operation unit 30 according to the operation information, the hold state information, and the operating finger identification information acquired from the hold state detection unit 26. When the DPF 10 is held in both hands, operations to the entire display area with fingers can be achieved without the need to move the fingers extensively by, for example, increasing the sensitivity of the first operation unit 28 and the second operation unit 30 and correlating the area that can be covered by the fingers with the entire display area. When the DPF 10 is placed on the desk, the second operation unit 30 on the rear side, which in this case is not used for operation and need only sense the lifting of the DPF 10, may have its sensitivity lowered to prevent an unintended operation.

Further, when the DPF 10 is held in the single hand, the user interface may be changed to facilitate the operations performed by the other hand not holding the DPF 10 by acquiring the hold state information from the hold state detection unit 26 to detect which of the right and left hands is holding the DPF 10.

The communication unit 34 is used to obtain content data, etc., such as still images and moving images, through a network for display on the DPF 10. The communication unit 34 is connected by wire or wirelessly to a network to acquire content data or other data from a personal computer (referred to as PC below), the Internet, and the like.

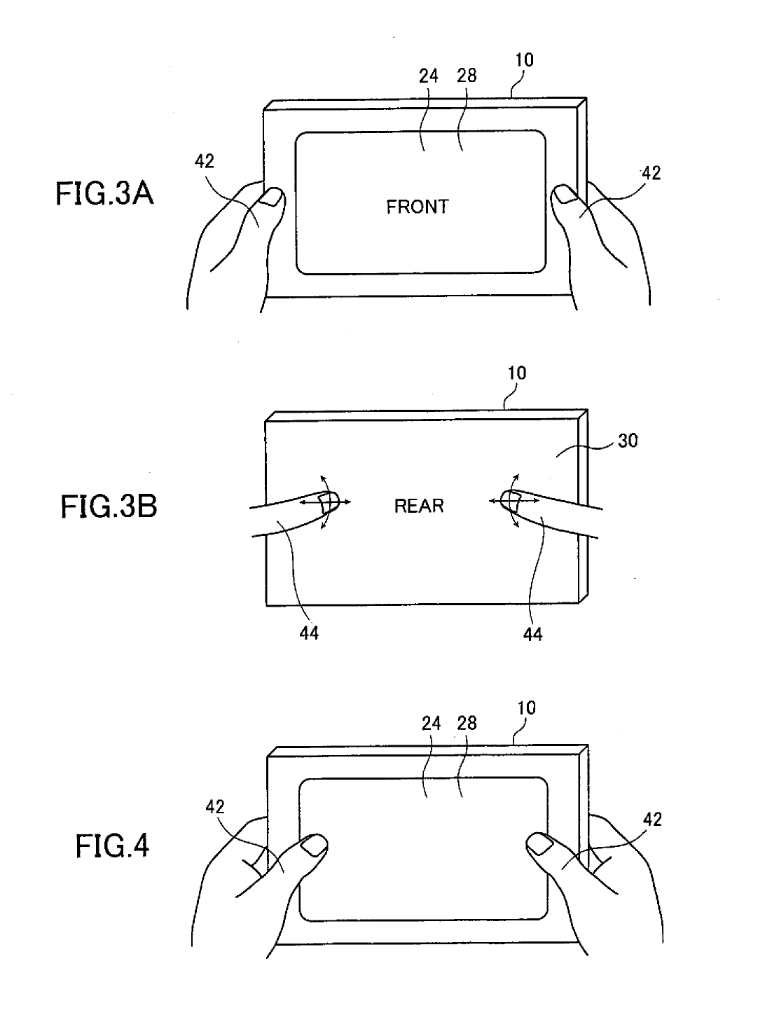

FIGS. 3A and 3B are views for explaining a first example of operation of the DPF 10 of the invention as it is held in both hands. Now, the effects of the first example of operation will be described referring to FIGS. 3A and 3B.

When viewing an image, etc. by holding the DPF 10 in both hands, the thumbs 42 are placed on the frame of the display unit 24 instead of the display area thereof to avoid obstructing the view of the image displayed on the display unit 24, so that the DPF 10 is held by the thumbs 42 with the other fingers placed on the rear side as illustrated in FIG. 3A.

The second operation unit 30 is held with the other fingers and operated by the index fingers 44, for example, as illustrated in FIG. 3B. The second operation unit 30, when operated, generates the operation signal and sends it to the hold state detection unit 26.

When the DPF 10 displays the still image, the index fingers 44 are moved on the second operation unit 30 upwards and downwards or rightwards and leftwards, or tapped thereon to scroll or rotate the image or, when images are viewed by way of a slideshow, fast forward, rewind, pause, and the like are performed. When the moving image is viewed, access to the start of a segment of interest, fast forward, rewind, pause, frame-by-frame advance, and the like are performed.

Thus, operations to the displayed content such as an image can be performed without obstructing the sight of the displayed content under viewing. The buttons, etc. for operating the first operation unit 28 are not displayed while viewing the image to prevent obstructing the sight of the displayed image, etc. Thus, the image displayed over the whole screen of the display 24 can be viewed without the view of the image being obstructed.

The hold state detection unit 26 generates operation information, hold state information, and operating finger identification information from the operation signal received from the second operation unit 30 and send these information to the image processor 20, the image display mode decision unit 22, etc.

In the example illustrated in FIGS. 3A and 3B, operation information of fast forward, rewind, pause, and the like used in the slideshow, etc. is generated using the operation signal associated with the operation by the index fingers 44. Since the fingers of both hands are in contact with the second operation unit 30 in the example illustrated in FIG. 3B, where not all the fingers are shown for simplicity, hold state information indicating that the DPF 10 is held in both hands is generated. Further, since the index fingers 44 performing the operations detach (hover) from the second operation unit 30 more frequently than the other fingers during operation, operating finger identification information indicating that the operating fingers are the index fingers is generated.

The image processor 20 performs image processing such as fast forward operation, scroll, etc. to the displayed content such as the image according to the operation information received from the hold state detection unit 26. Image-processed data such as image data is sent to the image display mode decision unit 22.

The image display mode decision unit 22 decides the display mode in which the display unit 24 displays data such as the image data received from the image processor 20 according to operation information, hold state information, and operating finger identification information.

In the example illustrated in FIGS. 3A and 3B, where the DPF 10 is held in both hands, the image display mode decision unit 22 decides to display data such as the image data received from the image processor 20 in the whole screen of the display unit 24 and not to display the operation buttons, etc. in the display unit 24. Based upon this decision, the image display mode decision unit 22 sends data such as the image data for display to the display unit 24, whereupon the display unit 24 displays the image, etc.

Next, a second example of operation according to the invention will be described. FIGS. 4 and 5 are views for explaining the second example of operation according to the invention. The DPF 10 according to the second example of operation illustrated in FIGS. 4 and 5 has the same configuration as the DPF 10 in the first example of operation. As illustrated in FIG. 4, when the DPF 10 is held in both hands, and operation such as selecting the image, etc. is performed, the operation buttons, etc. displayed in the display unit 24 can be operated with thumbs 42. Now, the description below will mostly focus upon the features where the operations of this example differ from those in the first example of operation illustrated in FIGS. 3A and 3B.

As illustrated in FIG. 4, since the thumbs 42 are short, operating the whole area of the first operation unit 28 by the thumbs 42 is impossible, when the DPF 10 is held in both hands. Accordingly, as illustrated in FIG. 5, the operation buttons, etc. are displayed in operation areas 46 located close to the right and left edges of the first operation unit 28 provided on the display unit 24. The operations performed using such buttons are detected by the first operation unit 28 as the operation signal, which are sent to the hold state detection unit 26.

The index fingers 44, longer than the thumbs 42, operate the central operation area 48, which cannot be reached by the thumbs 42 for operation, by using the second operation unit 30 provided on the rear side. When, for example, thumbnail images are displayed in the central area of the display unit 24 corresponding to the central operation area 48 for selection of the image, etc., the index fingers 44 are used to operate the second operation unit 30 for selection of the thumbnail image. Thus, the thumbnail image displayed in the central area of the display unit 24 corresponding to the central operation area 48 can be selected, and the corresponding operation is detected by the second operation unit 30 as the operation signal, which is sent to the hold state detection unit 26.

Thus, the DPF 10, held in both hands, allows various operations to be performed thereon using the first operation unit 28 and the second operation unit 30 provided on both sides of the DPF 10.

The hold state detection unit 26 generates operation information, hold state information, and operating finger identification information from the operation signals received from the first operation unit 28 and the second operation unit 30 and sends these information to the image processor 20, the image display mode decision unit 22, and the like.

In the examples illustrated in FIGS. 4 and 5, operation information for selecting the thumbnail image is generated from the operation signal associated with the operation by the index fingers 44, and operation information for operating the operation buttons is generated from operation signal associated with the operation by the thumbs 42. When the DPF 10 is held in both hands, no operating finger identification information is generated for operation on the first operation unit 28, which is in this case operated only by the thumbs 42.

The image processor 20 performs operation, image processing, and etc. according to the operation information received from the hold state detection unit 26. The results of operation and image-processed data such as image data are sent to the image display mode decision unit 22 to decide the display mode of the display unit 24 and an image according to the operation information and the like are displayed on the display unit 24.

Where the operator's hands are small or the DPF 10 is large for the hands in the second example of operation according to the invention, the index to little fingers may be unable to operate the whole area of the second operation unit 30 placed on the rear side of the DPF 10.

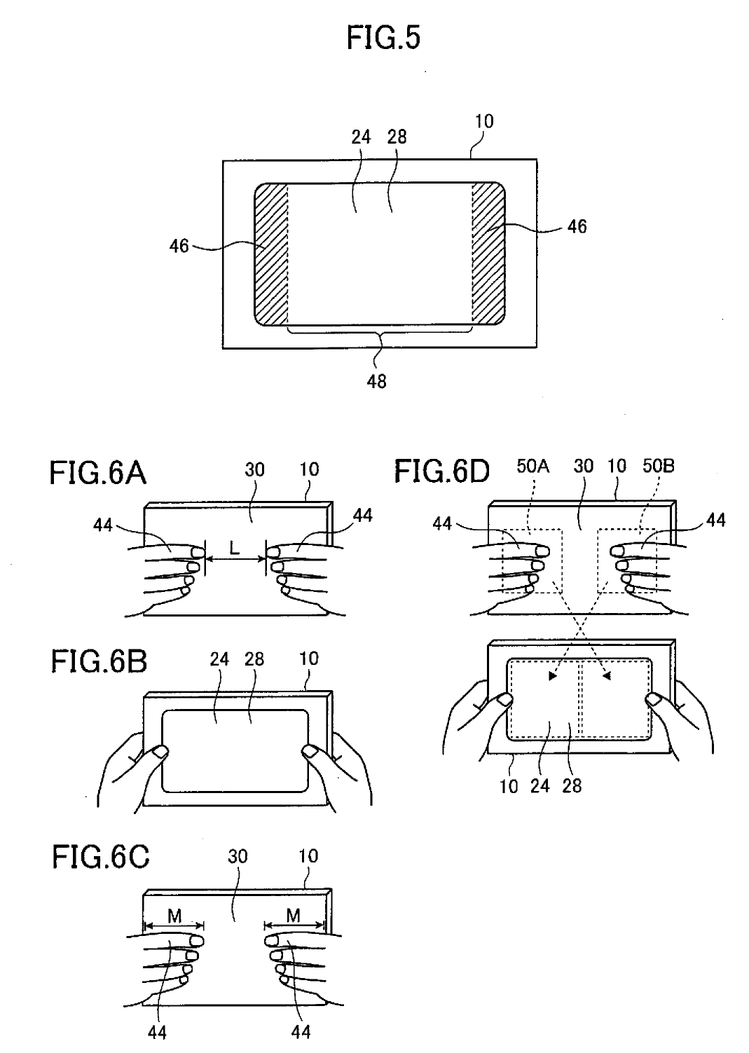

FIG. 6A illustrates the rear side of the DPF 10 in a case where the operator's hands are small or the DPF 10 is large for the hands; FIG. 6B illustrates the front side of the DPF 10. In the second operation unit 30 in FIG. 6A, there is a gap of length L between the operator's index fingers 44, 44 of both hands. As such, operation for the area corresponding to L is impossible.

Therefore, as illustrated in FIG. 6C, a length M of the operator's index fingers is detected from, for example, their positions in contact with the second operation unit 30 to estimate the movable ranges of the index fingers 44, 44.

Next, as illustrated in FIG. 6D, the estimated movable range 50A covered by the index finger 44 of the right hand is correlated with the right half of the display unit 24 on the front side, and the estimated movable range 50B covered by the index finger of the left hand 44 is correlated with the left half of the display unit 24 to permit operations on any position in the whole area of the display unit 24 using the movable ranges of the index fingers 44.

Since different operator holds the DPF 10 at a different position thereof for operation, the estimated movable ranges of the index fingers 44 may vary.

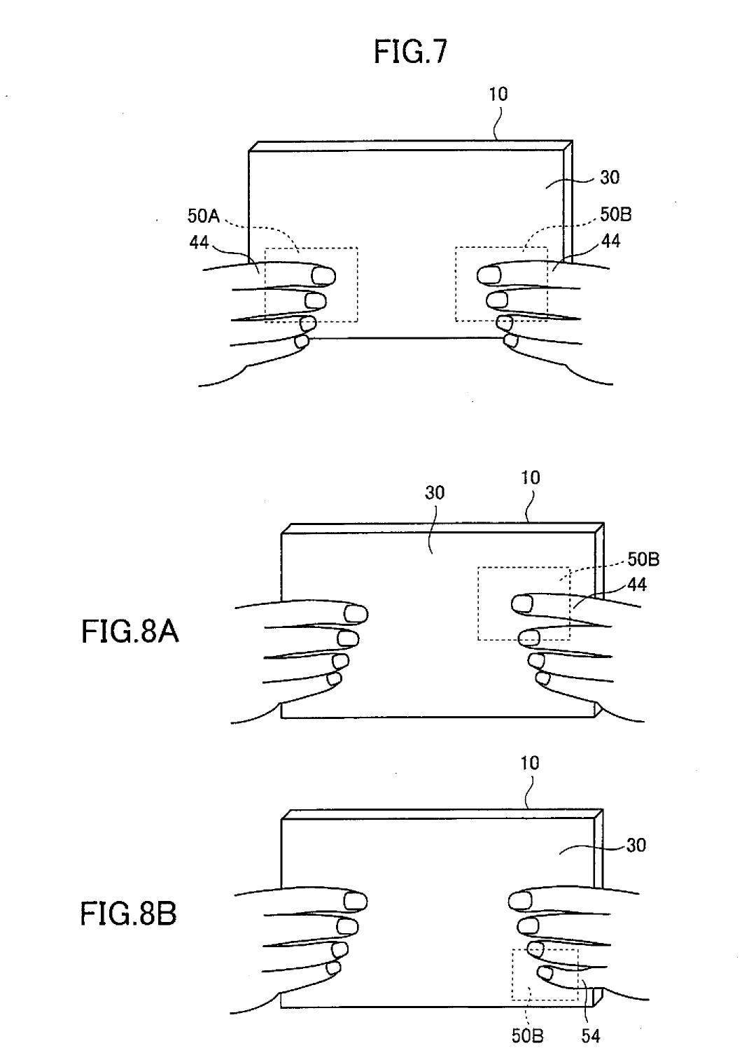

For example, when the operator holds lower areas of the DPF 10 as illustrated in FIG. 7, an estimation is made from the positions of the index through little fingers in contact with the second operation unit 30 that the operator holds the lower areas of the DPF 10, and the new movable ranges of the index fingers 44, 44 are estimated. Then, as in the example illustrated in FIG. 6D, new estimated movable ranges 50A and 50B covered by the index fingers 44 of the right and left hands can be correlated with the right and left halves of the display unit 24 to permit operations on any position in the whole area of the display unit 24 using the movable ranges of the index fingers 44.

While the index fingers are used for operation in the above examples illustrated in FIGS. 6A to 6D and 7, any of the index to little fingers may be used for operation.

To determine the operating finger out of the four fingers in contact with the second operation unit 30, it is noted that the operating finger is lifted off once from the second operation unit 30 before touching it again to perform an operation, i.e., the operating finger moves apart from the second operating unit 30 frequently. Thus, the one finger that is lifted off from the second operation unit 30 most frequently may be judged to be the operating finger.

As illustrated in FIG. 8A, for example, when the index finger 44 of the left hand is lifted, and the DPF 10 is supported with the other three fingers, the hold state detection unit 26 judges that the index finger 44 of the left hand is the operating finger from the operation signal sent from the second operation unit 30 and sends operating finger identification information to the operation control unit 32, etc.

Upon acquiring the operating finger identification information, the operation control unit 32 correlates the movable range 50B covered by the index finger 44 of the left hand with the whole area of the display unit 24 when only the index finger 44 of the left hand is judged to be the operating finger operating the second operation unit 30; the operation control unit 32 correlates the movable range 50B with the left half of the display unit 24 when the index fingers 44 of both hands are judged to be the operating fingers.

As illustrated in FIG. 8B, when the little finger 54 of the left hand is lifted, and the DPF 10 is supported with the other three fingers, the hold state detection unit 26 judges that the little finger 54 of the left hand is the operating finger from the operation signal sent from the second operation unit 30 and sends operating finger identification information to the operation control unit 32, etc.

As in the case where the index finger is used for operation, the operation control unit 32, upon acquiring the operating finger identification information, correlates the movable range 50B covered by the little finger 54 of the left hand with the whole area of the display unit 24 when only the little finger 54 of the left hand is judged to be the operating hand operating the second operation unit 30; the operation control unit 32 correlates the movable range 50B with the left half of the display unit 24 when the little fingers 54 of both hands are judged to be the operating fingers.

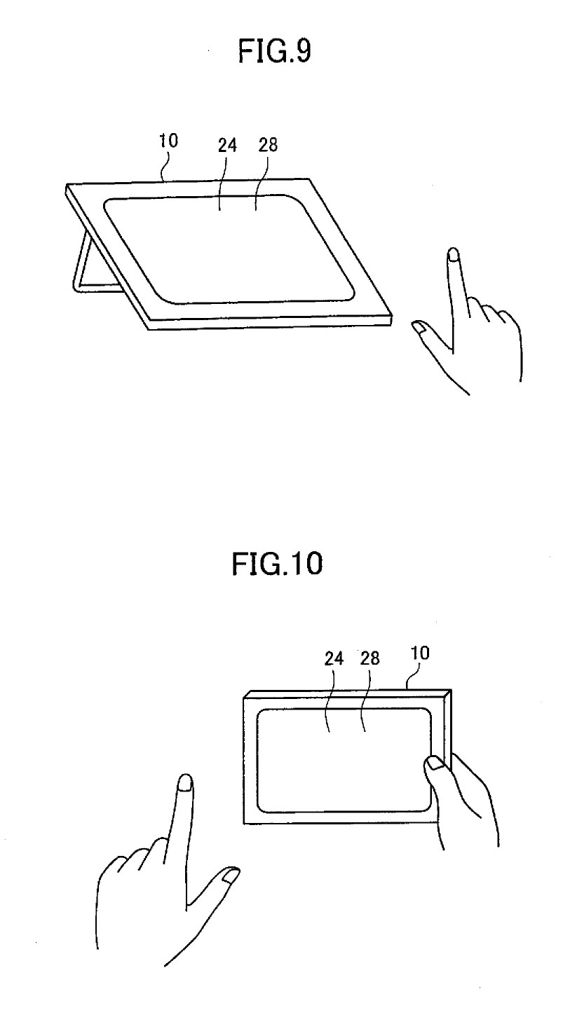

Next, a third example of operation according to the invention will be described. FIGS. 9 and 10 are views for explaining the third example of operation according to the invention. The DPF 10 according to the third example of operation illustrated in FIGS. 9 and 10 has the same configuration as the DPF 10 according to the second example of operation.

When performing operations such as selecting the image, etc., with the DPF 10 placed on the desk, for example. as illustrated in FIG. 9, or held in the single hand as illustrated in FIG. 10, the operation buttons, etc. displayed in the display unit 24 can be operated with a hand. Now, the description below will mostly focus upon the features where the operations of this example differ from those in the second example of operation illustrated in FIGS. 4 and 5.

The DPF 10 illustrated in FIG. 9 is placed on a desk, etc. Since the DPF 10 is not held in a hand or hands in this example of operation, operations using only the first operation unit 28 can be performed. The DPF 10 illustrated in FIG. 10 is held in a single hand, and the other hand left free can perform operations using only the first operation unit 28.

When performing the same operations as in the second example of operation, the operator at least has the other hand left free. Accordingly, unlike in the second example of operation, the whole area of the first operation unit 28 provided on the display unit 24 can be touched freely.

Since the operator can touch and operate the whole area of the first operation unit 28 whether the DPF 10 is placed on the desk or held in the single hand, the operation buttons, etc. may be displayed in areas close to the right and left edges of the screen corresponding to the operation areas 46 as in the second example of operation or in areas close to the upper and lower edges of the screen. An operation of selecting the thumbnail image can also be performed at any position on the screen.

In this case, the second operation unit 30 is not used. Therefore, when the operation control unit 32 has received hold state information from the hold state detection unit 26 that the DPF 10 is placed on the desk or that it is held in the single hand, the operation control unit 32 preferably sends the second operation unit 30 a control signal for lowering the sensitivity to reduce the sensitivity of the touch panel or the touch pad thereby to prevent an unintended operation.

The steps taken in the above image display method may be configured to be an image display program product for causing a computer to execute the steps of the image display method described above, or may be configured to be an image display program product enabling computers to function as means for executing the respective steps of the image display method or to function as means for forming components of the image display device described above.

Further, the above image display program product may be configured in the form of a computer readable medium or a computer readable memory.

While the image display device, image display method, and a program product according to the invention has been described in detail above, the present invention is not limited to the above embodiments, and various improvements and modifications may be made without departing from the spirit and scope of the invention.

What is claimed is:

1. An image display device for displaying an image comprising:
a display unit for displaying at least one of the image and an operation screen,
a first operation unit provided on the display unit and for generating an operation signal by detecting a contact with itself,
a second operation unit provided on a rear side of the display unit and for generating an operation signal by detecting a contact with itself,
a hold state detection unit for detecting a hold state of the image display device according to the operation signal generated by at least one of the first operation unit and the second operation unit,
an image display mode decision unit for determining an image display mode for displaying the image on the display unit according to the hold state detected by the hold state detection unit,
an image processor for determining a content of the image to be displayed on the display unit according to the hold state detected by the hold state detection unit, and
an operation control unit for controlling the first operation unit and the second operation unit according to the hold state detected by the hold state detection unit, wherein a user interface of the display unit is changed to a user interface corresponding to the hold state of the image display device by performing one or more of processing by the image display mode decision unit to change the image display mode for displaying the image on the display unit according to the detected hold state, processing by the image processor to change the content of the image to be displayed on the display unit according to the detected hold state, and processing by the operation control unit to change a method for controlling the first operation unit and the second operation unit according to the detected hold state.

2. The image display device of claim 1, wherein when the hold state detection unit detects that the first operation unit is operated by an operator's thumbs whereas the second operation unit is operated by one or more of the operator's index finger, middle finger, ring finger, and little finger, the hold state detection unit detects that the hold state is such that the image display device is held in the operator's both hands.

3. The image display device of claim 2, wherein when the hold state is such that the image display device is held in the operator's both hands, the image and the operation screen displayed in the display unit are associated with a movable range of one of the operator's fingers operating the second operation unit, the movable range being estimated by detecting a length of the one operating finger and being smaller than a screen of the display unit.

4. The image display device of claim 3, wherein the movable range of the one finger operating the second operation unit is changed according to a position where the image display device is supported.

5. The image display device of claim 3, wherein when three fingers of the index finger, middle finger, ring finger, and little finger are in contact with the second display unit, remaining one finger is judged to be the one finger operating the second operation unit.

6. The image display device of claim 1, wherein the second operation unit is also provided on a lateral side of the display unit.

7. The image display device of claim 1, wherein when the hold state is such that the image display device is placed on a desk or a table or held in the operator's single hand, the image display device is operated using only the first operation unit.

8. The image display device of claim 1, wherein the first operation unit provided on the display unit is a touch panel.

9. The image display device of claim 1, wherein a display unit for displaying at least one of the image and the operation screen is provided also on the rear side.

10. The image display device of claim 9, wherein the second operation unit is a touch panel provided on the display unit on the rear side.

11. The image display device of claim 1, wherein the image display device is a digital photograph frame.

12. An image display device for displaying an image comprising:
a display unit for displaying at least one of the image and an operation screen,
a first operation unit provided on the display unit and for generating an operation signal by detecting a contact with itself,
a second operation unit provided on a lateral side of the display unit and for generating an operation signal by detecting a contact with itself,
a hold state detection unit for detecting a hold state of the image display device according to the operation signal generated by at least one of the first operation unit and the second operation unit,
an image display mode decision unit for determining an image display mode for displaying the image on the display unit according to the hold state detected by the hold state detection unit,
an image processor for determining a content of the image to be displayed on the display unit according to the hold state detected by the hold state detection unit, and
an operation control unit for controlling the first operation unit and the second operation unit according to the hold state detected by the hold state detection unit,
wherein a user interface of the display unit is changed to a user interface corresponding to the hold state of the image display device by performing one or more of processing by the image display mode decision unit to change the image display mode for displaying the image on the display unit according to the detected hold state, processing by the image processor to change the content of the image to be displayed on the display unit according to the detected hold state, and processing by the operation control unit to change a method for controlling the first operation unit and the second operation unit according to the detected hold state.

13. The image display device of claim 12, wherein when the hold state is such that the image display device is placed on a desk or a table or held in the operator's single hand, the image display device is operated using only the first operation unit.

14. The image display device of claim 12, wherein the first operation unit provided on the display unit is a touch panel.

15. The image display device of claim 12, wherein a display unit for displaying at least one of the image and the operation screen is provided also on the lateral side.

16. The image display device of claim 15, wherein the second operation unit is a touch panel provided on the display unit on the lateral side.

17. The image display device of claim 12, wherein the image display device is a digital photograph frame.

18. An image display method for displaying an image on an image display device comprising a display unit for displaying the image and an operation screen, a first operation unit provided on the display unit, and a second operation unit provided on a rear side of the display unit, comprising the steps of:
a step of displaying the image and the operation screen on the display unit,
a step of generating a first operation signal by detecting through the first operation unit a contact with the first operation unit itself,
a step of generating a second operation signal by detecting through the second operation unit a contact with the second operation unit itself,
a step of detecting a hold state of the image display device according to at least one of the first operation signal and the second operation signal,
a step of determining an image display mode for displaying the image on the display unit according to the hold state,
a step of determining a content of the image to be displayed on the display unit according to the hold state,
a step of controlling the display unit, the first operation unit and the second operation unit according to the hold state, and
a step of changing a user interface of the display unit to a user interface corresponding to the hold state of the image display device by changing, according to the hold state, one or more of the image display mode of the image, the content of the image, and a method for controlling the first operation unit and the second operation unit.

19. A program product for causing a computer to execute an image display method for displaying an image on an image display device comprising a display unit for displaying the image and an operation screen, a first operation unit provided on the display unit, and a second operation unit provided on a rear side of the display unit, the program product comprising the steps of:
a step of displaying the image and the operation screen on the display unit,
a step of acquiring a first operation signal generated by detecting through the first operation unit a contact with the first operation unit itself,
a step of acquiring a second operation signal generated by detecting through the second operation unit a contact with the second operation unit itself,
a step of detecting a hold state of the image display device according to at least one of the first operation signal and the second operation signal,
a step of determining an image display mode for displaying the image on the display unit according to the hold state,
a step of determining a content of the image to be displayed on the display unit according to the hold state,
a step of controlling the display unit, the first operation unit and the second operation unit according to the hold state, and
a step of changing a user interface of the display unit to a user interface corresponding to the hold state of the image display device by changing, according to the hold state, one or more of the image display mode of the image, the content of the image, and a method for controlling the first operation unit and the second operation unit.

20. The program product of claim 19, wherein the computer is a computer forming a part of the image display device.
